(19) United States
(12) Patent Application Publication
(10) Pub. No.: US 2014/0379852 A1
(43) Pub. Date: Dec. 25, 2014

(54) SYSTEM AND METHOD FOR SUBSCRIBING TO A CONTENT STREAM

(71) Applicant: Harish Nair Rajagopal, Trivandrum (IN)

(72) Inventor: Harish Nair Rajagopal, Trivandrum (IN)

(73) Assignee: WIPRO LIMITED, Bangalore (IN)

(21) Appl. No.: 13/961,224

(22) Filed: Aug. 7, 2013

(30) Foreign Application Priority Data
Jun. 20, 2013 (IN) 2675/CHE/2013

(51) Int. Cl. H04L 29/08

(52) U.S. Cl. CPC H04L 67/02
USPC 709/217

(57) ABSTRACT

This disclosure generally relates to content distribution, and more particularly to a system and method for subscribing to a content stream. In one embodiment, a content subscription method is disclosed, comprising: receiving, at a subscriber electronic device, a publisher program schedule including a media item indication of a media item accessible to a publisher electronic device from a source; identifying, via the subscriber electronic device, a source accessible to the subscriber electronic device for the media item, wherein the source accessible to the subscriber electronic device comprises at least one of: the source accessible to the publisher electronic device, and/or a source not accessible to the publisher electronic device; accessing, via the subscriber electronic device, the media item from the source accessible to the subscriber electronic device in accordance with the publisher program schedule; and storing a portion of the accessed media item.

### PRIORITY CLAIM

This U.S. patent application claims priority under 35 U.S.C. §119 to: India Application No. 2675/CHE/2013, filed Jun. 20, 2013, and entitled “SYSTEM AND METHOD FOR SUBSCRIBING TO A CONTENT STREAM.” The aforementioned application is incorporated herein by reference in its entirety.

### TECHNICAL FIELD

This disclosure generally relates to content distribution, and more particularly to a system and method for subscribing to a content stream.

### BACKGROUND

Consumers these days have access to an ever-increasing amount of media content from a variety of sources. Numerous content providers offer media content to consumers, either free of charge or for a price. For example, a consumer may register on an online audio streaming service and may access millions of song files of different artists and from different genres. Similarly, video streaming services allow a consumer to search for and view videos that may be of interest to the consumer. In some cases, the consumer may be allowed to create a personalized playlist by aggregating preferred media content available with the service provider in an order of preference. Once the personalized playlist is created by the consumer, the service provider may stream media content to the user in accordance with the personalized playlist. Thus, the consumer may consume preferred media items in a preferred order by creating a playlist.

### SUMMARY

In one embodiment, a content subscription method is disclosed, comprising: receiving, at a subscriber electronic device, a publisher program schedule including a media item indication of a media item accessible to a publisher electronic device from a source; identifying, via the subscriber electronic device, a source accessible to the subscriber electronic device for the media item, wherein the source accessible to the subscriber electronic device comprises at least one of: the source accessible to the publisher electronic device, and/or a source not accessible to the publisher electronic device; accessing, via the subscriber electronic device, the media item from the source accessible to the subscriber electronic device in accordance with the publisher program schedule; and storing a portion of the accessed media item.

In one embodiment, a content subscription apparatus is disclosed, comprising: at least one processor; and a memory storing instructions executable by the at least one processor, wherein the instructions comprise instructions to: receive a publisher program schedule including a media item indication, wherein a media item is accessible to a publisher electronic device from a source; identify a source accessible for the media item, wherein the source accessible for the media item comprises at least one of: the source accessible to the publisher electronic device, and a source not accessible to the publisher electronic device; access the media item from the source accessible for the media item in accordance with the publisher program schedule; and store a portion of the accessed media item.

In one embodiment, a non-transitory computer readable medium is disclosed, having stored thereon computer-executable content access instructions comprising instructions for: receiving a publisher program schedule including a media item indication, wherein a media item is accessible to a publisher electronic device from a source; identifying a source accessible for the media item, wherein the source accessible for the media item comprises at least one of the source accessible to the publisher electronic device and a source not accessible to the publisher electronic device; accessing the media item from the source accessible for the media item in accordance with the publisher program schedule; and storing a portion of the accessed media item.

### BRIEF DESCRIPTION OF THE DRAWINGS

FIG. 1 illustrates an exemplary environment in which various embodiments may function.

FIG. 2 illustrates a flowchart of a method of subscribing to a content stream in accordance with some embodiments.

FIG. 3 illustrates an exemplary representation of a program schedule in accordance with some embodiments.

FIG. 4 illustrates a block diagram for identifying one or more sources accessible to a subscriber electronic device in accordance with some embodiments.

FIG. 5 illustrates a block diagram of a subscriber electronic device for subscribing to a content stream in accordance with some embodiments.

FIG. 6 illustrates a block diagram of a system for subscribing to a content stream in accordance with some embodiments.

### DETAILED DESCRIPTION

Now, exemplary embodiments of the present disclosure will be described with reference to the accompanying drawings. Wherever possible, the same reference numbers will be used throughout the drawings to refer to the same or like parts. While exemplary embodiments and features are described herein, modifications, adaptations, and other implementations are possible, without departing from the spirit and scope of the disclosure. Accordingly, the following detailed description does not limit the subject matter. Instead, the proper scope of the subject matter is defined by the appended claims.

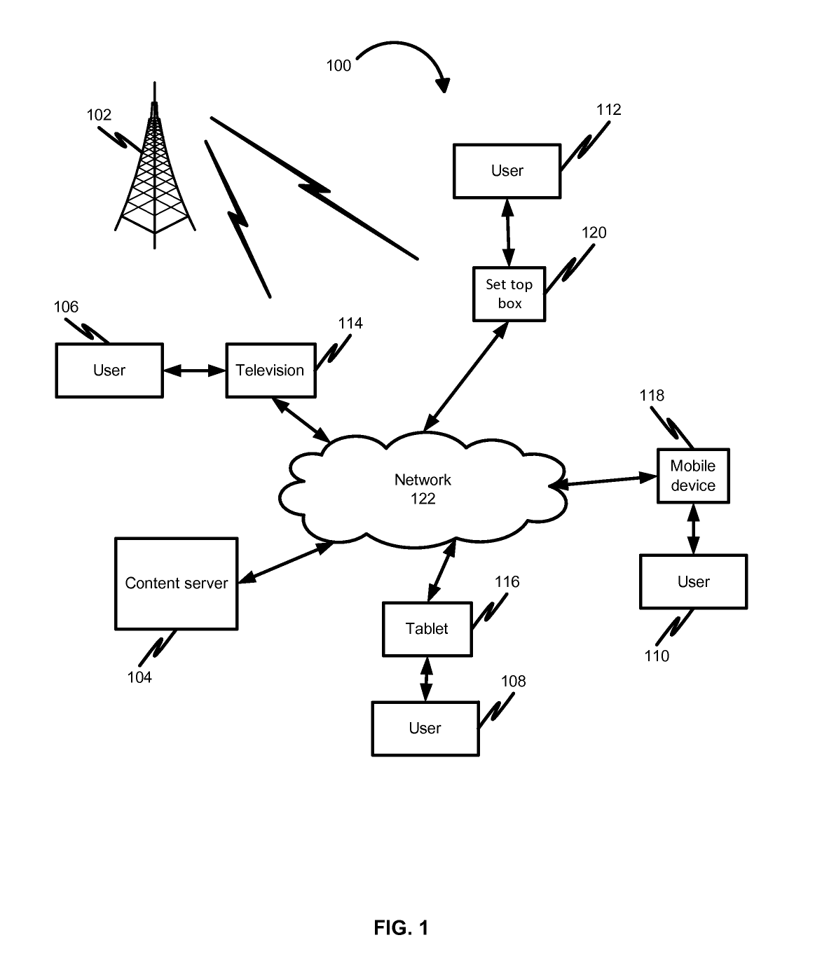

FIG. 1 illustrates an environment 100 in which various embodiments may function. Environment 100 may include a broadcast station 102, a content server 104, a user 106, a user 108, a user 110, a user 112, a television (TV) 114, a tablet 116, a mobile device 118, and a set top box (STB) 120. User 106 may access broadcast programs broadcasted by broadcast station 102 using TV 114. TV 114 may be configured to receive broadcast signals transmitted by broadcast station 102, process the received broadcast signals and subsequently render the associated broadcast programs to be consumed by user 106. In some embodiments, a desktop computer, laptop computer, tablet, smartphone, digital radio, or other electronic device capable of providing audio and/or visual content to User 106, may replace TV 114. Similarly, STB 120 may also be configured to receive broadcast signals from broadcast station 102 and present the associated broadcast programs to user 106 via a TV display (not shown in FIG. 1). In some embodiments, a desktop computer, laptop computer, tablet, smartphone, digital radio, or other electronic device capable of receiving audio and/or visual data, may replace STB 120. In some embodiments, broadcast station 102 may be a cellular telecommunications tower, an Internet server, a Wi-Fi™ hotspot, a router, a switch, a hub, or other electronic device capable of transmitting audio and/or visual data.

In some instances, TV 114 and STB 120 may further be configured to access a network such as network 122. For example, TV 114 and STB 120 may be operably coupled to a network device (such as a network interface device, router, hub, switch, etc.) via twisted pair cables, coaxial cables, fiber-optic lines, Wi-Fi™ connection(s), cellular (e.g., 3G/4G) connection(s), or the like. TV 114 and STB 120 may be able to obtain data from other devices operably connected to network 122 via the network device. In some embodiments, network 122 may correspond to the Internet. TV 114 and STB 120 may be used by user 106 and user 112 respectively to access one or more content servers such as content server 104 over network 122. Content server 104 may provide one or more media items such as, but not limited to, audio files and video files to user 106 and user 112 over network 122.

Further, user 108 may use a hand held processing device such as a tablet 116 to access one or more media items from content server 104 over network 122. Similarly, user 110 may access content from content source 104 using a mobile device 118. In some other configurations, user 108 and user 110 may access TV programs over network 122 by using tablet 116 and mobile device 118 respectively if the TV programs are maintained at a content server such as content server 104. It will be apparent to a person skilled in the art that other processing devices configured to connect to a network or a broadcast station may be used to access content from a content server or a broadcaster without deviating from the scope of the disclosure.

Such handheld or mobile devices may utilize wired or wireless connection options, similar to those discussed above, to operably connect to network 122 and access content from servers or other content sources.

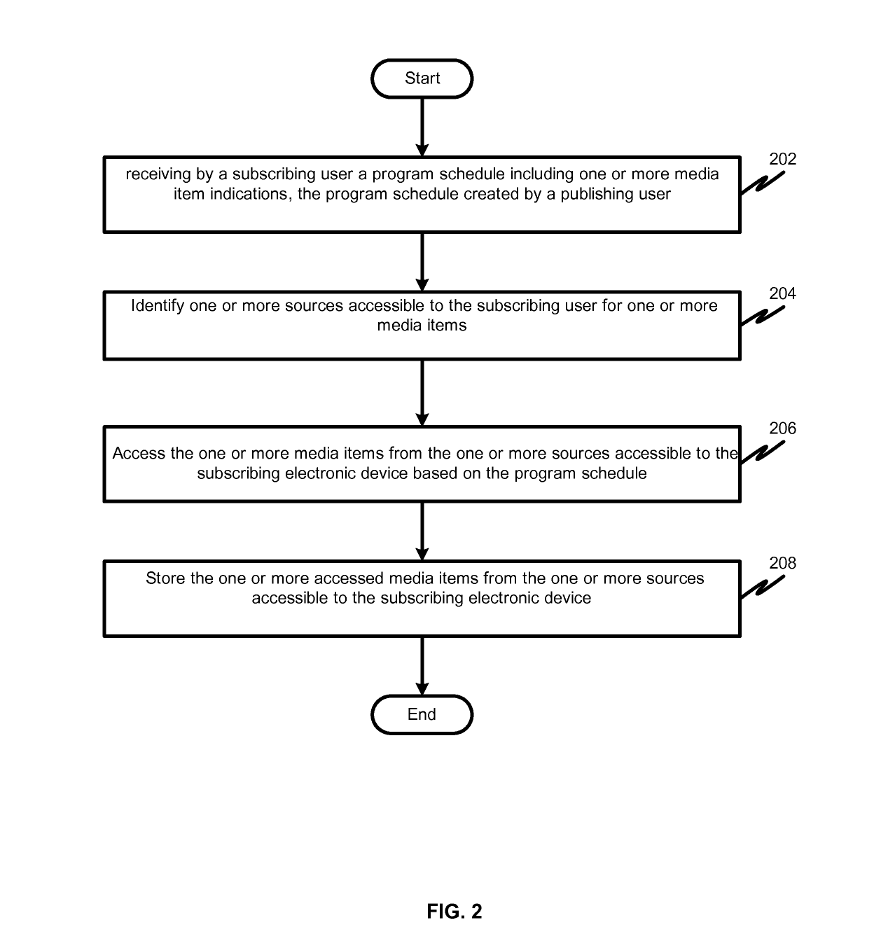

FIG. 2 illustrates a flowchart of a content subscription method in accordance with some embodiments. At step 202, a subscriber electronic device may receive a program schedule that includes one or more media item indications corresponding to one or more media items. The subscriber electronic device may be associated with a subscribing user. In some embodiments, the subscribing user may identify one or more program schedules that are of interest from a repository and subscribe to these program schedules. In some other embodiments, the subscribing user may subscribe to program schedules shared directly with the subscribing user by other users.

A program schedule may be created by a publishing user by using a publisher electronic device associated with the publishing user by aggregating one or more media item indications corresponding to one or more media items. The subscriber electronic device and publisher electronic device can be any of the devices disclosed above corresponding to TV 114, Tablet 116, Mobile device 118, and STB 120 in the description with reference to FIG. 1. The one or more media items may be accessible from one or more sources accessible to the publisher electronic device. In some embodiments, a media item indication may include a title of a media item. In this case, the publisher program schedule may be a listing of titles of the media items that are of interest to the publishing user. In some embodiments, a media item indication may include any of: a title of a media item, a graphic associated with the media item (e.g., a barcode, a Quick Response (QR) code, a poster, a screenshot, a video frame, an advertisement, etc.), a unique identifier (e.g., an encryption key, unique alphanumeric sequence, etc.), a uniform resource locator (URL), or the like. The publishing user may look up one or more content catalogs associated with one or more content servers and also an Electronic Program Guide (EPG) associated with a TV broadcast to select media items of interest. For example, a display device (e.g., TV, computer, smartphone, digital radio, etc.) may display the content catalogs or EPG for the publishing user. The publishing user may navigate through the content catalogs or EPG using a remote control, mouse, keyboard, joystick, or other input device operably coupled to a publisher electronic device, and may provide inputs to the publisher electronic device. Thus, the publishing user may select these media items to create a program schedule. For example, the user may create a program schedule, using the publisher electronic device, by selecting an indication of a broadcast program from a particular TV broadcast channel and an indication of a video file from a video streaming service.

When the publishing user creates a publisher program schedule, metadata associated with media items in the publisher program schedule may also be imported into the program schedule. The metadata associated with the media item may include, but is not limited to, broadcast time of the media item if the media item is a broadcast program, duration of the media item, a short description of the media item, a rating associated with the media item, a genre or category of the media item, a file extension of the media item, names of personalities associated with the media item, etc. For example, when the publishing user creates a program schedule by selecting a broadcast program, metadata such as the broadcast channel associated with the broadcast program, the time at which the broadcast program is scheduled to be broadcast, and the duration of the broadcast program may be imported into the program schedule.

In some embodiments, in addition to the metadata, information regarding the source where the media item was available may also be imported into the schedule. For example, name, URL or network address corresponding to the source where the media item was available may be included in the program schedule.

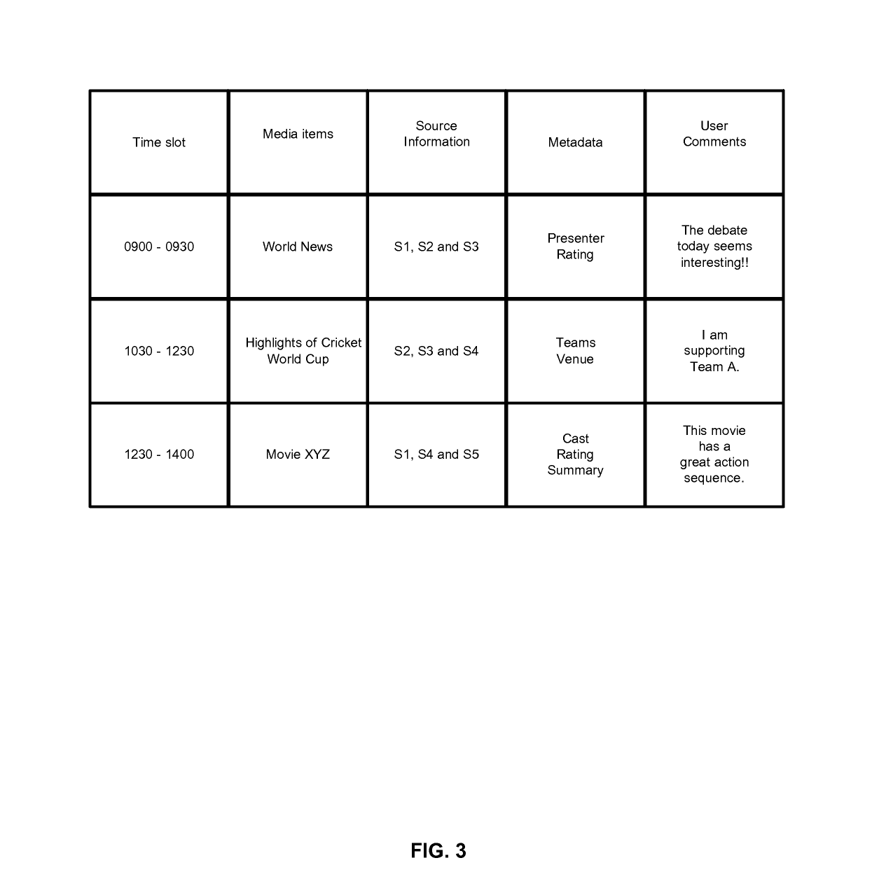

An exemplary program schedule will now be explained in conjunction with FIG. 3. A user may create a program schedule by creating a list of preferred media items from various sources such as, but not limited to, a TV broadcast, an online streaming service, one or more content servers, or the like. A time slot preferred by the publishing user for viewing the media items may also be specified in some embodiments. To create the program schedule, the publishing user may search a catalog or program listing maintained by various content sources. As illustrated in FIG. 3, if the user finds the media item “World News” at source S1, the source information associated with source S1 and the metadata associated with the media item “World News” may be imported into the program schedule when the user includes “World News” in the program schedule. In some embodiments, URLs or network addresses corresponding to the source S1 may also be included in the program schedule. In case “World News” corresponds to a broadcast program, the publishing user may access an Electronic Program Guide (EPG) associated with a broadcast TV channel in order to select the media item “World News” to include in the program schedule. The publishing user may then include the media item and a preferred time slot corresponding to the media item in a program schedule. The publishing user may do so by using the publisher electronic device.

In case of broadcast programs, if the scheduled time of broadcast of the broadcast program does not match with the publishing user's preferred time for that broadcast program, alternate sources where the broadcast program is available at the user's preferred time may be determined. For example, the publisher electronic device may provide a query (e.g., a structured query language (SQL) query to a relational database management system, a Hypertext Transfer Protocol (HTTP) GET request, etc.) to a database (stored either at the publisher electronic device or at some other device, e.g., a server) for alternate sources where the broadcast program is available at the user's preferred time. In some embodiments, the broadcaster may provide the broadcast programs at the user's preferred time. In some other embodiments, the user may request the broadcaster to provide the broadcast program prior to the preferred time. The broadcast program may then be stored locally at the publisher electronic device associated with the publishing user and played from the publisher electronic device at the preferred time.

Further, the publishing user may include one or more comments regarding the media items. The comments may represent the publishing user's opinion or rating of the media item and may serve as a reference for subscribing users. The publishing user may then publish the program schedule in a repository or a database for use by other users. In some embodiments, the publishing user may directly provide the program schedule to other users over one or more communication media such as, but not limited to, a social network, email, instant messenger, or the like. The program schedule can be encoded in a variety of data formats, including, without limitation: XML, JSON, an ASCII file, a text file, a spreadsheet (e.g., a Microsoft® Excel file), or the like.

On receiving the published program schedule, the subscriber electronic device associated with the subscribing user may identify, at step 204, one or more sources that are accessible to the subscriber electronic device for the one or more media items. For example, the subscriber electronic device may parse the program schedule received from the publisher electronic device, and extract the media items indications, metadata, and any other data included in the program schedule. Using the extracted information, the subscriber electronic device may provide a query (e.g., a structured query language (SQL) query to a relational database management system, a Hypertext Transfer Protocol (HTTP) GET request, etc.) to a database (stored either at the subscriber electronic device or at some other device, e.g., a server) for sources that are accessible to the subscriber electronic devices for the one or more media items for which media item indications are included in the program schedule. The one or more identified sources may include one or more sources that were accessible to the publisher electronic device. The one or more identified sources may also include one or more sources that were not accessible to the publisher electronic device.

In some embodiments, the sources that are accessible to the subscriber electronic device for the media items may be determined automatically. Here, the sources may be automatically identified based on the media item indication and/or metadata associated with the media item in the program schedule. For example, the subscriber electronic device may search each of the sources accessible to the subscriber electronic device using the media item indication and/or metadata of the media item indicated in the program schedule to find sources that include the media items. In some embodiments, the publishing user may predefine a number of sources within which to search for the media item.

In some embodiments, substantially similar variants of the media item may also be identified. As a non-limiting example, two media items may be considered substantially similar if their media item indications and their metadata substantially match. The two media items may be considered as substantially similar if their titles are substantially similar and/or an extent of match between their metadata is above a predefined threshold (e.g., a fixed percentage, score, grade, etc.) for determining a substantial match. For example, a media item indication in the program schedule may indicate a title of a video “Animal attacks.” The metadata for this video may provide information such as duration of the video, a summary of the video, name of a cameraman of the video, and a resolution of the video. Another video “Animal attacks HD” may have a similar summary, an equivalent duration, and the same cameraman as the video “animal attacks” but may have a higher resolution than the video “Animal attacks”. As an example, a predefined threshold for determining a substantial match may specify that at least 75% of the metadata should match between the two videos to consider one video a variant of the other. Thus, the two videos “Animal attacks” and “Animal attacks HD” may be considered as substantially similar to each other because of the substantially similar titles and due to the metadata of the two videos matching the predefined threshold.

In another non-limiting example, a video “Funny movie scenes in year 2012” may have a slightly longer duration (e.g., an additional 0-30 seconds) but a similar summary as a second video having the same title. The slightly longer duration of the video “Funny movie scenes in year 2012” may be attributed to advertisements embedded in the video. However, because the two videos have similar summaries and the titles of both the videos match with each other to a significant extent, the two videos may be considered as substantially similar to each other.

Other non-limiting examples of media items that may be considered to substantially match each other include: media items that have graphical differences (e.g., additional text, logos, labels, etc. in one, but not the other) in only a few of their frames (e.g., less than 5% of frames); media items that have the same graphical content, but at different screen resolutions, video quality, frame rate, etc.; media items where their differences are only in metadata associated with the media items; media items that may be considered substantially similar under the U.S. copyright laws; or the like, and media items that have combinations of such differences.

It is to be understood that when identifying a source accessible to the subscriber electronic device for the media item, a media item at the source accessible to the subscriber electronic device need only be a substantial match to the media item at the source accessible to a publisher electronic device.

In some embodiments, the subscriber electronic device may store results of the searching of sources accessible to the subscriber electronic device for the media items. The results may be used to create a mapping table. The mapping table may include names of sources associated with each media item from where the media item may be accessible by the subscriber electronic device. The subscribing user for a media item may refer to the mapping table at a later time. The mapping table may provide the user information regarding the sources accessible to the subscriber electronic device for the media item. In some embodiments, the mapping table may also be shared by the subscribing user with another user along with a program schedule or separately from the program schedule.

The mapping table may be updated each time a search for sources accessible for the media item is conducted. A user may manually add newly discover sources accessible to the subscriber electronic device for the media item to the mapping table. Alternately, the subscriber electronic device may automatically include such newly discovered sources in the mapping table.

In some embodiments, the subscriber electronic device may select sources based on criteria such as computing capability of the subscriber electronic device, available bandwidth of a network through which the subscriber electronic device is connected to a source, display capability of the subscriber electronic device, user privileges, and device privileges. For example, if the subscriber electronic device is able to play high resolution videos, the subscriber electronic device may select a source that provides high resolution media items. In another example, a user may be allowed to access content from a particular source only if the user's age is above 18 years. In yet another example, a user may be allowed to access content from a particular source only if the user's credentials meet the security requirements specified by the source.

According to some embodiments, the sources accessible to the subscriber electronic device for a media item may be identified based on a user profile data. The subscriber electronic device may store user profile data based on usage analytics of various subscribing users that may use the subscriber electronic device. The user profile data may include details about, but not limited to, age, sex, location, interests, favorite actors, favorite genres, etc. of the subscribing user. The subscribing device may identify suitable sources accessible for the media item by considering the user profile data for the subscribing user.

The subscriber electronic device may refer to the source information associated with a media item indicated in the program schedule to identify sources accessible to the subscriber electronic device for a media item. The subscribing user may access the media item from the sources in the source information that represents sources accessible to the publishing user. However, if the subscriber electronic device is not able to access the media item from the sources mentioned in the source information, one or more sources accessible to the subscriber electronic device may be identified by the subscribing electronic device as discussed in step 204 of FIG. 2. In some embodiments, the one or more identified sources that are accessible to the subscriber electronic device may be included in the mapping table. The mapping table may be referred by the subscribing user while accessing the same media item in future or by other subscribers with whom the subscribing user shares the program schedule.

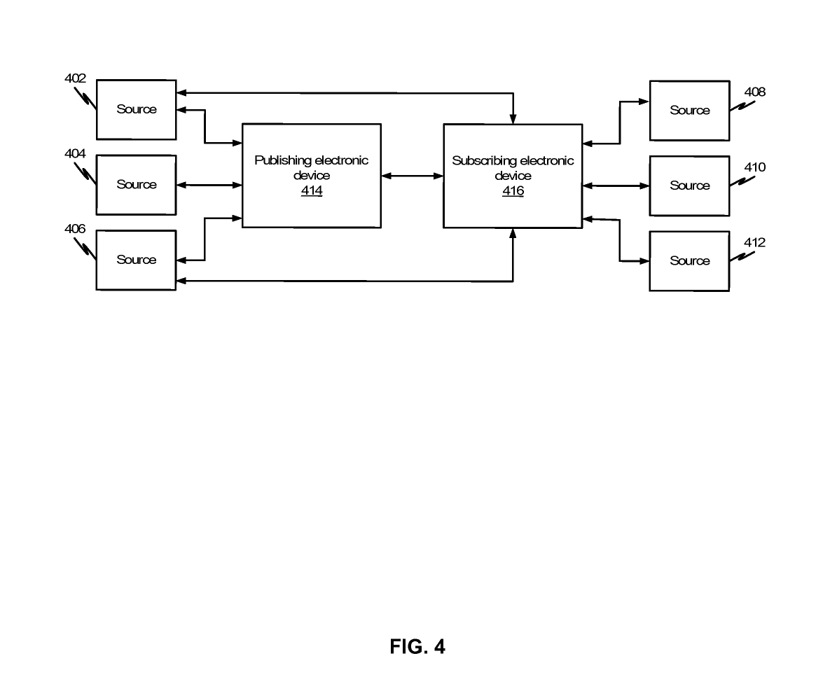

In some embodiments, the subscribing user associated with the subscriber electronic device may manually search for sources from where a media item in the program schedule may be accessed. The subscribing user may query a content catalog or an EPG associated with the sources accessible to the subscriber electronic device to identify sources where the media item is available. In some embodiments, the subscribing user may query the content catalog or the EPG using metadata associated with the media item indicated in the program schedule. For example, the subscribing user may query each of the sources accessible to the subscriber electronic device using the title of a media item as keywords. Each of the sources accessible to the subscriber electronic device may return results representing all the media items having those keywords. If the number of results returned is large, the user may further refine the result set by including additional keywords. The subscribing user may then select those sources which return results representing the media item according to the requirements of the subscribing user. FIG. 4 illustrates a block diagram of an exemplary method of identifying one or more sources accessible to a subscriber electronic device. FIG. 4 illustrates sources 402-412, a publisher electronic device 414 and a subscriber electronic device 416. Publisher electronic device 414 used by a publishing user may be able to access sources 402, 404, and 406. Further, subscriber electronic device 416 used by a subscribing user may be able to access sources 402, 406, 408, 410, and 412.

In some embodiments, to identify one or more of sources 402, 406, 408, 410, and 412 that have a media item, a content catalog or an EPG associated with each of sources 402, 406, 408, 410, and 412 may be automatically searched by subscriber electronic device 416. Exemplarily, subscriber electronic device 416 may discover that source 410 provides the media item.

Referring back to FIG. 2, at step 206, the subscriber electronic device may access the one or more media items from the one or more sources accessible to the subscriber electronic device for the one or more media items in accordance with the program schedule. At step 208, the subscriber electronic device may store the accessed media items from the one or more sources accessible to the subscribing electronic device. The subscribing electronic device may store the media item in its memory such as a hard-disk such that the media item can be retrieved later from the memory of the subscribing electronic device. In some embodiments, the subscribing electronic device may store the media item temporarily in a buffer of the subscribing electronic device. For example, the subscribing electronic device may buffer a portion of a video being streamed from a video streaming website.

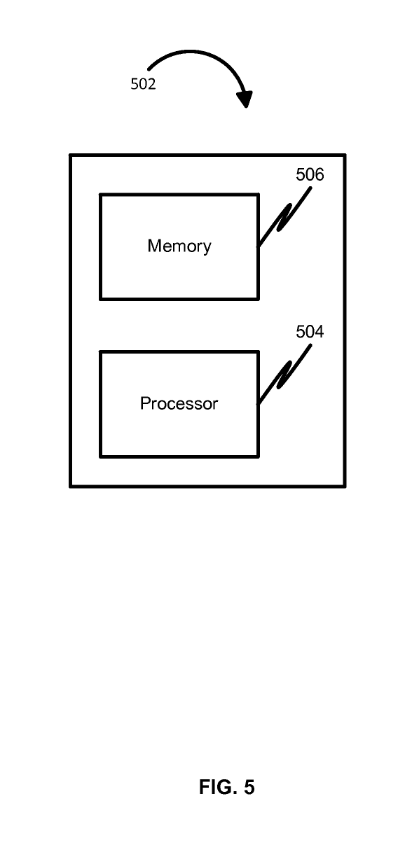

FIG. 5 illustrates a block diagram of a subscriber electronic device 502 for subscribing to a content stream associated with a program schedule. The program schedule received by the subscribing device may include one or more media item indications corresponding to one or more media items. Subscriber electronic device 502 may include one or more processors such as a processor 504 and a memory 506 storing instructions executable by the one or more processors, wherein the one or more processors are configured by the instructions to receive a program schedule created by a publishing user by using a publisher electronic device. The program schedule may be created by the publishing user by aggregating the one or more media item indications corresponding to the one or more media items. The one or more media items may be accessible from one or more sources accessible to the publisher electronic device. The instructions executable by the one or more processors may further include instructions to identify one or more sources accessible for one or more media items indicated in the program schedule. Identification of sources for the media items is explained in detail in conjunction with FIG. 2. The one or more sources accessible for the one or more media items may include one or more sources accessible to the publisher electronic device and/or one or more sources not accessible to the publisher electronic device. The instructions may further include instructions to access the one or more media items from the one or more sources and for storing the one or more media items in memory 506.

Memory 506 may store these programmed instructions for one or more aspects of the present disclosure as described and illustrated herein. The programmed instructions can be in the form of computer programs or applications that are accessible to users of subscriber electronic device 502. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to processor 504, can be used for memory 506 in subscriber electronic device 502.

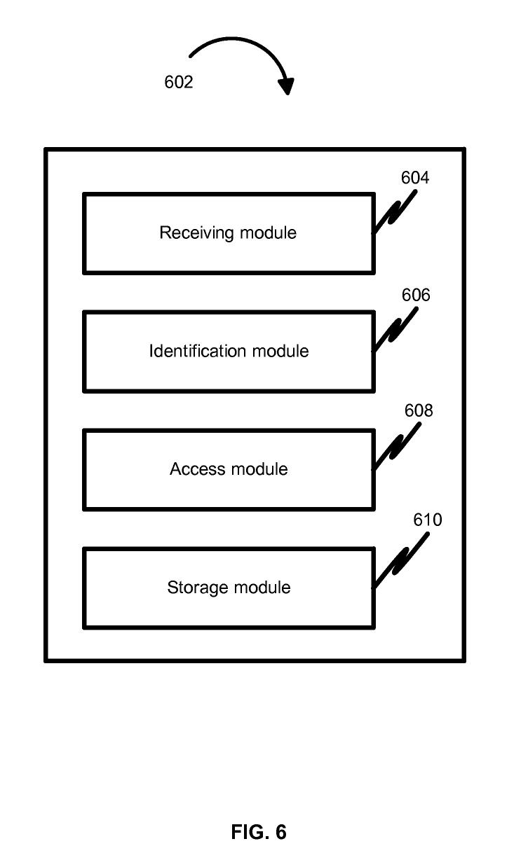

FIG. 6 illustrates various modules of a system 600 for subscribing to a content stream associated with a program schedule. System 600 may include a receiving module 604 configured to receive a program schedule created by a publishing user. The publishing user may create the program schedule by aggregating one or more media item indications corresponding to one or more media items. The one or media items may be accessible from one or more sources accessible to the publisher electronic device. System 602 may further include an identification module 606 configured to identify one or more sources accessible to system 602 for one or more media items in the program schedule. The one or more sources accessible for the one or more media items may include one or more sources accessible to the publisher electronic device and/or one or more sources not accessible to the publisher electronic device. System 602 may further include an access module 608 configured to access the one or more media items from the one or more sources accessible for the one or more media items in accordance with the program schedule.

Subscriber electronic device 602 may further include a storage module 610 configured to store the one or more media items. In some embodiments, storage module 610 may perform the functions of a buffer to temporarily store a portion of the media item as discussed in conjunction with FIG. 2.

This disclosure provides a number of advantages including, without limitation, methods, non-transitory computer readable media, apparatuses, and systems that enable identification of sources accessible to a subscriber electronic device for a media item indicated in a program schedule. Since, the subscriber electronic device can identify additional sources apart from the sources indicated in the program schedule, the subscribing user is not restricted to access a media item from a source from where a publishing user accesses the media item. Thus, the disclosure enables the subscribing user to select sources that the subscribing user may find suitable to the subscribing user's requirements.

It should be understood that the apparatuses and devices of the embodiments described herein are for exemplary purposes, as many variations of the specific hardware and software used to implement the embodiments are possible, as will be appreciated by those skilled in the relevant art(s).

Furthermore, each of the devices of the embodiments may be conveniently implemented using one or more general purpose computers, microprocessors, digital signal processors, and micro-controllers, specifically programmed according to the teachings of the embodiments, as described and illustrated herein, and as will be appreciated by those ordinary skill in the art.

The embodiments may also be embodied as one or more non-transitory computer readable medium having instructions stored thereon for one or more aspects of the present disclosure as described and illustrated by way of the embodiments herein, as described herein, which when executed by a processor, cause the processor to carry out the steps necessary to implement the methods of the embodiments, as described and illustrated herein.

Having thus described the basic concept of the disclosure, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the disclosure. Additionally, the recited order of processing elements or sequences, or the use of numbers, letters, or other designations therefore, is not intended to limit the claimed processes to any order except as may be specified in the claims. Accordingly, the disclosure is limited only by the following claims and equivalents thereto.

What is claimed is:

1. A content subscription method, comprising:
receiving, at a subscriber electronic device, a publisher program schedule including a media item indication of a media item accessible to a publisher electronic device from a source;
identifying, via the subscriber electronic device, a source accessible to the subscriber electronic device for the media item, wherein the source accessible to the subscriber electronic device comprises at least one of: the source accessible to the publisher electronic device, and/or a source not accessible to the publisher electronic device;
accessing, via the subscriber electronic device, the media item from the source accessible to the subscriber electronic device in accordance with the publisher program schedule; and
storing a portion of the accessed media item.

2. The method of claim 1, wherein the publisher program schedule is selected manually by a subscribing user.

3. The method of claim 1, wherein identifying the source accessible to the subscriber electronic device for the media item comprises querying, using the media item indication, a content catalog associated with the source accessible to the subscriber electronic device.

4. The method of claim 3, further comprising: creating a mapping table based on a result of the querying; wherein the mapping table comprises a mapping between the media item indication and the source for the media item.

5. The method of claim 1, wherein identifying the source accessible to the subscriber electronic device for the media item is based on at least one of: computing capability of the subscriber electronic device, bandwidth capability of the subscriber electronic device, display capability of the subscriber electronic device, a user privilege, and/or a device privilege.

6. The method of claim 1, wherein the publisher program schedule comprises metadata associated with the media item, wherein the metadata for the media item is obtained from the source accessible to the publisher electronic device.

7. The method of claim 6, wherein identifying the source accessible to the subscriber electronic device for the media item is based on the metadata associated with the media item.

8. The method of claim 1, wherein storing the portion of the accessed media item includes buffering the portion of the accessed media item.

9. The method of claim 8, further comprising: providing for display the buffered portion of the accessed media item.

10. A content subscription apparatus, comprising:
at least one processor; and
a memory storing instructions executable by the at least one processor, wherein the instructions comprise instructions to:
receive a publisher program schedule including a media item indication, wherein a media item is accessible to a publisher electronic device from a source;
identify a source accessible for the media item, wherein the source accessible for the media item comprises at least one of: the source accessible to the publisher electronic device, and a source not accessible to the publisher electronic device;
access the media item from the source accessible for the media item in accordance with the publisher program schedule; and
store a portion of the accessed media item.

11. The apparatus of claim 10, wherein the publisher program schedule to be received is selected manually by a subscribing user.

12. The apparatus of claim 10, wherein the instructions further comprise instructions to: identify the source accessible for the media item by querying, using the media item indication, a content catalog associated with the source accessible for the media item.

13. The apparatus of claim 10, wherein the instructions further comprise instructions to: create a mapping table based on a result of the querying, wherein the mapping table comprises a mapping between the media item indication and the source for the media item.

14. The apparatus of claim 10, wherein the instructions comprise instructions to: identify the source accessible for the media item based on at least one of: available computing capability, available bandwidth, display capability, a user privilege, and/or a device privilege.

15. The apparatus of claim 10, wherein the publisher program schedule comprises metadata associated with the media item, wherein the metadata for the media item is obtained from the source accessible to the publisher electronic device.

16. The apparatus of claim 15, wherein the instructions further comprise instructions to: identify the source accessible for the media item based on the metadata associated with the media item.

17. The apparatus of claim 10, wherein the instructions to store the portion of the accessed media item include instructions to buffer the portion of the accessed media item.

18. The apparatus of claim 17, wherein the instructions further comprise instructions to: provide for display the buffered portion of the accessed media item.

19. A non-transitory computer readable medium having stored thereon computer-executable content access instructions comprising instructions for:
receiving a publisher program schedule including a media item indication, wherein a media item is accessible to a publisher electronic device from a source;
identifying a source accessible for the media item, wherein the source accessible for the media item comprises at least one of the source accessible to the publisher electronic device and a source not accessible to the publisher electronic device;
accessing the media item from the source accessible for the media item in accordance with the publisher program schedule; and
storing a portion of the accessed media item.

20. The medium of claim 19, wherein the publisher program schedule is selected manually by a subscribing user.

21. The medium of claim 19, wherein identifying the source accessible for the media item comprises querying, using the media item indication, a content catalog associated with the source accessible for the media item.

22. The medium of claim 19, further comprising creating a mapping table based on results of the querying, wherein the mapping table comprises a mapping between the media item indication and the source for the media item.

23. The medium of claim 19, wherein the publisher program schedule comprises metadata associated with the media item, wherein the metadata for the media item is obtained from the source accessible to the publisher electronic device.

24. The medium of claim 19, wherein identifying the source accessible for the media item is based on the metadata associated with the media item.

25. A content subscriber system, comprising:
a receiving module configured to receive a publisher program schedule including a media item indication, wherein a media item is accessible to a publisher electronic device from a source;
an identification module configured to identify a source accessible for the media item, wherein the source accessible for the media item comprises at least one of the source accessible to the publisher electronic device and a source not accessible to the publisher electronic device;
an access module configured to access the media item from the source accessible for the media item in accordance with the publisher program schedule; and
a storage module configured to store a portion of the accessed media item.
